(19) United States
(12) Patent Application Publication
(10) Pub. No.: US 2011/0174931 A1
(43) Pub. Date: Jul. 21, 2011

(54) Airborne guidance unit for precision aerial delivery

(76) Inventor: Jean C. Berland, Wynnewood, PA (US)

(21) Appl. No.: 12/656,154

(22) Filed: Jan. 19, 2010

(51) Int. Cl. B64D 17/00

(52) U.S. Cl. 244/152

(57) ABSTRACT

An AGU adapted for one-time use is provided for use with a parachute. The AGU has a frame made of wood, plywood or other biodegradable material to which the parachute suspension lines are secured. The frame includes an exterior wall having an access portal to a compartment within which an avionics unit is mounted so that one side of the avionics unit remains exposed and substantially flush with the exterior wall. The avionics unit is secured to the frame around the perimeter of the access portal using connecting elements that can be removed by accessing only the exterior wall of the frame so that the avionics unit can be easily removed following deployment. The AGU also includes a harness that is wrapped around at least a part of the AGU frame and which provides multiple attachment points for securing of the AGU to the parachute suspension lines as well as to a payload, eliminating the need for any harness structural attachment points on the AGU frame.

### BACKGROUND OF THE INVENTION

1. Field of the Invention

The present invention relates in general to precision cargo delivery using an unmanned aerial vehicle and, more particularly, to an airborne guidance unit (AGU) with removable avionics and integrated harness adaptable for one-time-use.

2. Description of the Related Art

Precision cargo delivery relies upon unmanned aerial vehicles (UAVs) to guide cargo parachutes to preselected coordinates. The UAV includes an airborne guidance unit (AGU) having a structural frame that contains at least one battery, a motor, an avionics computer with GPS receiver, a motor controller, a processor, etc. A compass or other rate sensing instrument may also be included.

The precision cargo delivery parachute systems are similar to those used in personnel parachutes and can include low gliding round parachutes and higher gliding ram-air parachutes. Often the parachute systems have many operational procedures, such as the release of the deployment brakes after full inflation, that are normally carried out by personnel and therefore must be automated in the cargo application. An AGU capable of controlling these operations is therefore required.

One AGU-controlled solution offering a deployment brake release system that is not complex while being highly reliable and reusable is the precision aerial delivery system described in co-pending U.S. application Ser. No. 11/645,029, issuing as U.S. Pat. No. 7,648,105 on Jan. 19, 2010 (hereinafter “the '105 patent”), commonly owned by the assignee of the present application. The '105 patent is hereby expressly incorporated in the present application by reference as is fully set forth herein.

The precision aerial delivery unit of the '105 patent is designed for multiple uses and incorporates materials and manufacturing techniques to ensure a long service life, with the unit intended to be recovered after each mission and reused.

However, in certain operational missions during which a precision aerial delivery unit is dropped, it is not feasible to recover the unit due to its size and overall weight. As a result, the unit and its valuable components are left at the drop zone. These components, which include the metal AGU frame, can potentially be recovered and used by hostile forces to make improvised explosive devices (IEDs) and other weapons. Hence, the loss of the UAV not only helps the enemy but also results in a high single-use cost when a precision aerial delivery unit constructed for multiple uses is only able to be used once.

Accordingly, a need exists for a precision aerial delivery system having a less expensively designed AGU that, while still fully effective in accurately delivering cargo to a specified location, has a non-metal frame that is simply constructed so that it can be used cost-effectively on a single-use basis.

### SUMMARY OF THE INVENTION

In view of the foregoing, the present invention is directed to a precision aerial delivery system having a deployment brake release system for use with an airborne guidance unit (AGU) of a parachute suitable for precision cargo delivery and adapted for one-time use. While primarily directed to high-gliding ram-air parachutes, the present invention is applicable to any parachute having a requirement for steering line stowage or deflection upon opening, including low gliding round parachutes.

In one embodiment, the cargo-delivery parachute according to the present invention includes deployment brake lines secured at one end to the trailing edge of the ram air canopy and connected adjacent the other end to the motor of the AGU. As in the '105 patent, the deployment brake release system preferably includes at least one hook mount on the AGU frame. Looped ends of the deployment brake lines are engaged with the hook during rigging so that, upon deployment, opening forces are applied to the hook mount rather than to the motor. After full canopy inflation, the motor pulls on the looped ends of the brake lines to disengage the lines from the hook mount. By pulling the brake lines off the hook mount, the brake line loads are thus transferred to the AGU motor for the duration of the flight.

To provide for cost-effective single use, the AGU according to the present invention includes a non-metal frame to which the motor and motor control lines are secured. The frame, preferably made of wood, plywood or other organic biodegradable material, includes an exterior wall having an access portal that defines an entranceway to a compartment formed within the frame. An electromagnetically and environmentally sealed avionics unit is received within the compartment through the access portal so that, when fully mounted, only one side of the avionics unit is exposed; preferably, this exposed side is substantially flush with the exterior wall when the avionics unit is mounted in the frame. The avionics unit is secured to the frame around the perimeter of the access portal using connecting elements that can be removed by accessing only the exterior wall of the frame. This external accessibility allows the avionics unit, when being recovered in the field, to be easily and quickly removed by recovery personnel, while the remainder of the non-metal AGU frame is left at the drop site. Because the frame is made of wood, there are fewer elements that can be used by insurgents or other hostile forces to make IEDs.

The AGU frame according to the present invention includes an integrated harness that eliminates the requirement for structural attachment points on the AGU frame. The harness extends securely through and around the AGU frame and provides multiple attachment points for attaching the AGU to the parachute suspension lines as well as to the payload.

It is therefore an object of the present invention to provide an AGU that is capable of precision delivery of cargo while being specifically designed for one-time use.

Another object of the present invention is to provide a one-time-use AGU having an avionics unit that can be readily removed from the remainder of the AGU.

A further object of the present invention is to provide a one-time-use AGU with an integrated harness for attachment to canopy that eliminates the need for structural attachment points on the AGU frame.

Yet another object of the present invention is to provide a one-time-use AGU in accordance with the preceding objects having a deployment brake release system in which the AGU motor is not subjected to opening force loads, thus enabling motors of lower cost and lighter weight to be used.

A still further object of the present invention is to provide a one-time-use AGU in accordance with the preceding objects having a relatively simple deployment brake release system for use with UAVs that employs a hook mount on the AGU frame for taking up the initial canopy opening forces.

Yet another object of the present invention is to provide a one-time-use AGU with deployment brake release system in accordance with the preceding objects that can be readily adapted to fit and work effectively with a wide range of UAV parachute sizes and styles without requiring adaptation of the existing parachute structure.

It is yet another object of the invention to provide an AGU that is not complex in structure and which will conform to conventional forms of manufacture so as to be economically feasible for one-time use.

These together with other objects and advantages which will become subsequently apparent reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

FIG. 1 illustrates a ram air parachute following deployment with a one-time-use AGU in accordance with the present invention.

FIG. 2 is a close-up photograph of the AGU of FIG. 1 in a deployed state.

FIG. 3 is a photograph of the AGU of FIG. 2, shown prior to deployment and as rigged with a parachute and payload.

FIG. 4 is a drawing illustrating a rear perspective view of the AGU of FIGS. 1-3, including the deployment brake release hook mount and spools.

FIG. 5 is a drawing of the AGU illustrated in FIG. 4, shown with the upper panel removed to reveal the internal components as installed in the AGU frame.

FIG. 6 is a drawing illustrating a bottom perspective view of the AGU shown in FIG. 4.

FIG. 7 is a drawing illustrating a right side perspective view of the AGU frame shown in FIG. 4 with the avionics unit removed.

FIG. 8 is a photograph of the right side of the AGU frame shown in FIG. 7, with the avionics unit partially removed from the AGU frame.

FIG. 9 is another photograph of the right side of the AGU frame of FIG. 7, showing the avionics unit removed from but adjacent to the AGU frame.

FIG. 10 is a drawing illustrating the left side of the AGU as shown in FIG. 6.

FIG. 11 is a photograph showing a top view of the AGU, including the top panel of the frame and the upper straps of the harness.

FIG. 12 is a photograph showing a bottom view of the AGU of FIG. 11, including the lower panel of the frame and the lower straps of the harness as secured to the anchors.

FIG. 13 is an illustration of the rigging configuration of the front and back straps of the harness relative to the AGU frame in accordance with the present invention.

FIG. 14 is an illustration of the rigging configuration of the middle strap of the harness relative to the AGU frame in accordance with the present invention.

### DETAILED DESCRIPTION OF THE PREFERRED EMBODIMENTS

In describing preferred embodiments of the invention illustrated in the drawings, specific terminology will be resorted to for the sake of clarity. However, the invention is not intended to be limited to the specific terms so selected, and it is to be understood that each specific term includes all technical equivalents which operate in a similar manner to accomplish a similar purpose.

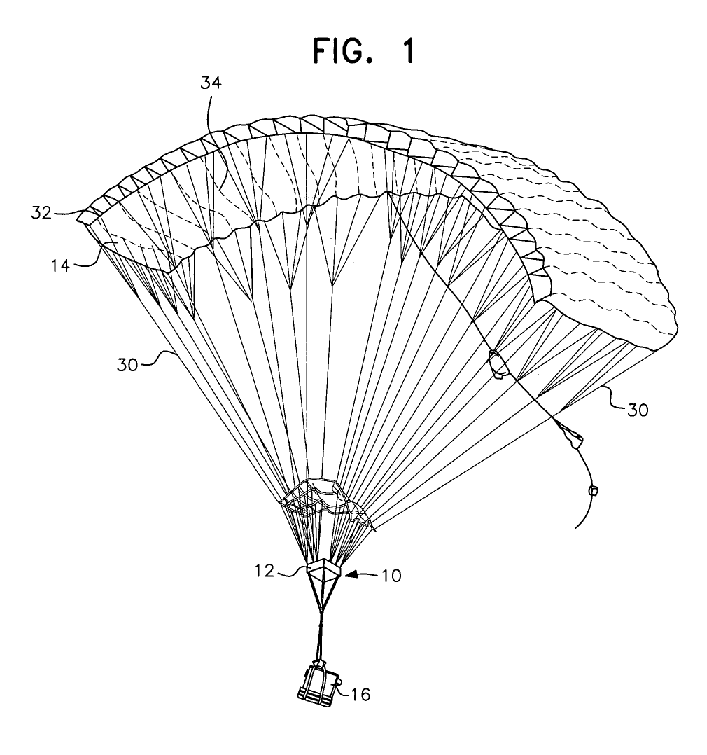

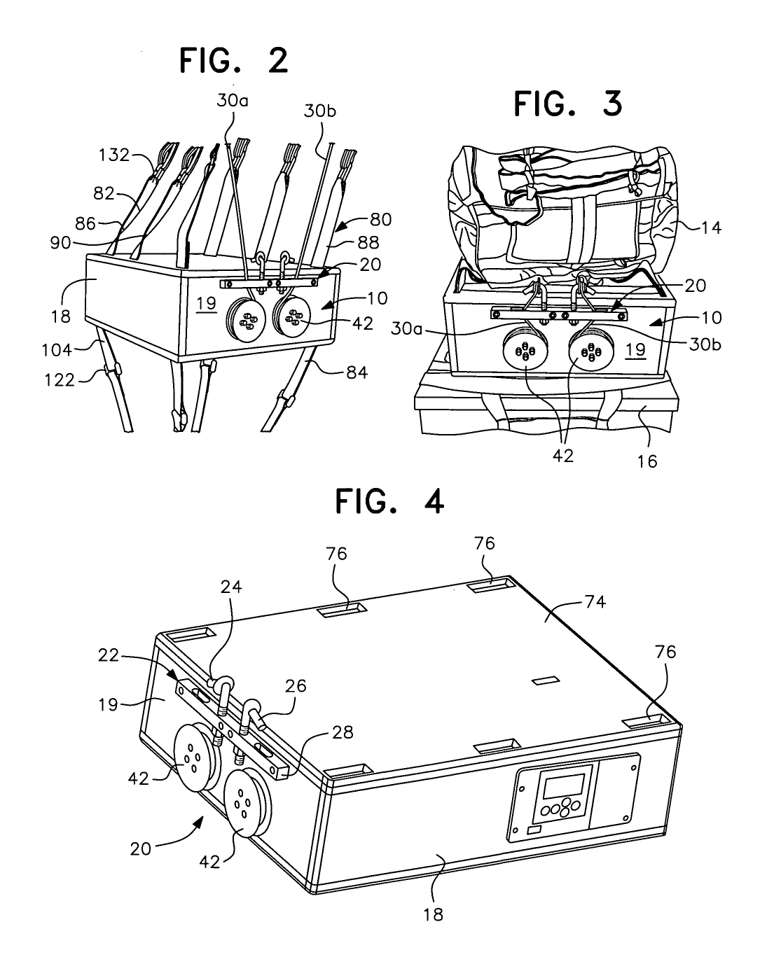

As shown in the photograph of FIG. 1, the one-time-use AGU of the present invention, generally designated by the reference numeral 10, is part of an unmanned aerial vehicle (UAV) 12 designed for use with a ram air parachute 14 carrying a payload 16 that is controlled by the AGU to direct the parachute 14 in flight. As shown in FIG. 1, the parachute and AGU have been deployed and are in flight. An enlarged view of the AGU and harness, as deployed with its suspension line and payload attachments, is shown in FIG. 2.

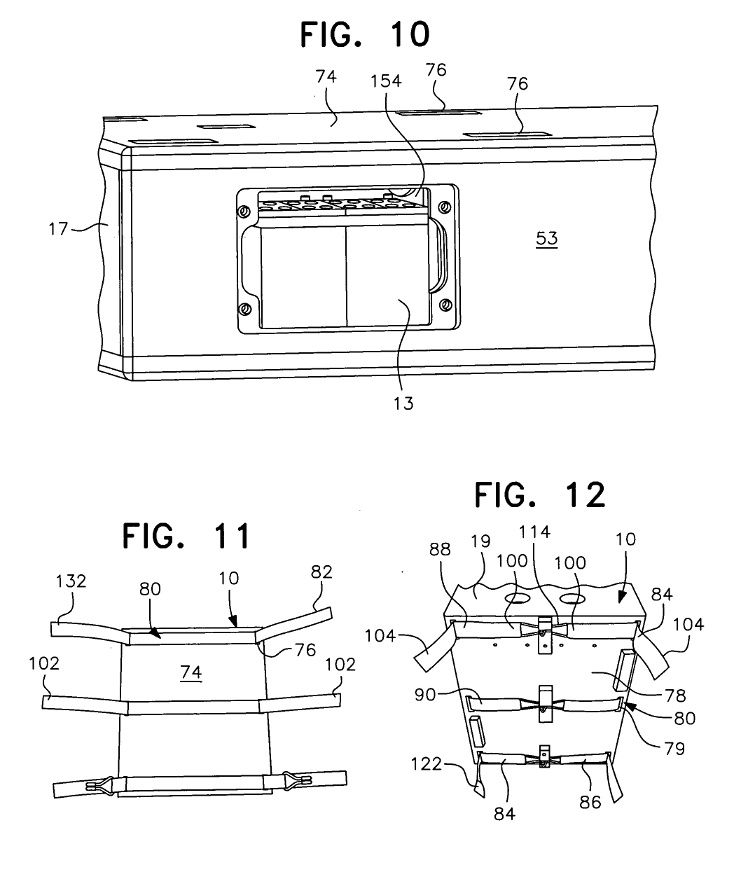

The AGU of FIG. 2, prior to deployment and as rigged with a parachute and payload, is shown in FIG. 3. The one-time-use AGU 10 includes an AGU frame 18 with a deployment brake release system, generally designated by the reference numeral 20. The frame includes a top panel 74, a bottom panel 75 (see FIG. 6), a front side wall 17 (see FIG. 10), a rear side wall 19, a right side wall 52 and a left side wall 53. The panels 74, 75 and side walls 17, 19, 52, 53 are each preferably made of a suitable thickness of wood, plywood and/or other laminated wood products, or other organic/biodegradable materials that provide structural strength. Wood and/or plywood are preferred materials due to their modest cost and structural strength which make the AGU both sufficiently durable in use and economically disposable thereafter.

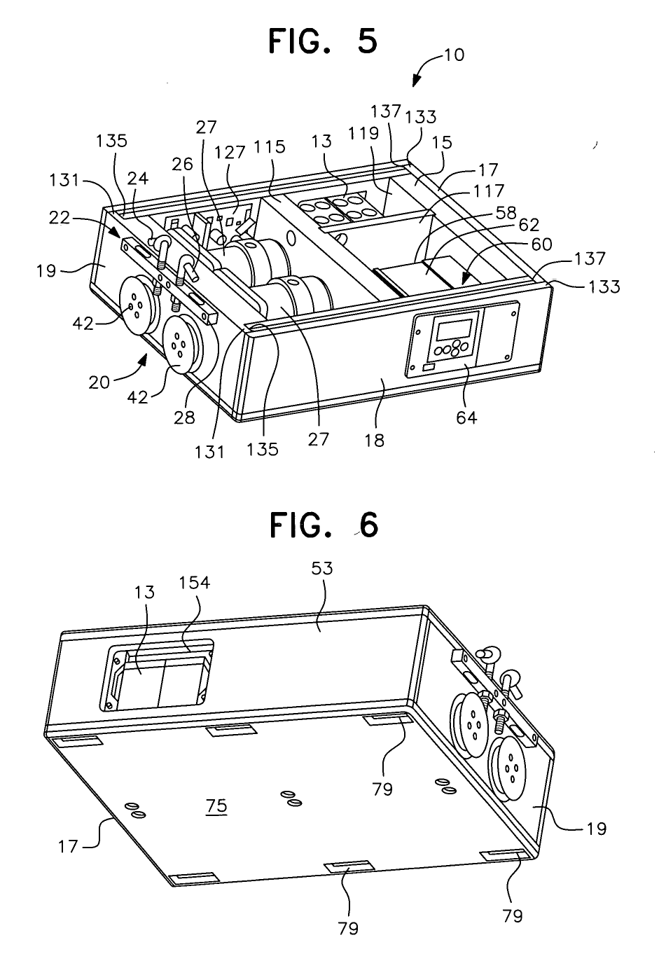

As shown in FIG. 5, the front wall 17, as well as any of the other walls, may be reinforced by a separate lateral beam 15 positioned behind and in abutment with the subject wall. In addition, one or more other wooden or plywood beams may be positioned within the frame such as lateral beam 115 which extends transversely to the right and left side walls 52, 53. Notches 135, 137 are preferably formed in the ends of the right and left side walls to receive the ends 131, 133 of the front and rear side walls, respectively, in an interlocking relationship that reinforces the strength of the frame 18.

The AGU is secured to the parachute and the payload by an integrated harness generally designated by reference numeral 80. The harness includes upper straps 82 for connection with the suspension lines 13 and lower straps 84 for coupling to the payload 16.

As best seen in the rear perspective views shown in FIGS. 4 and 5, the one-time-use AGU includes a deployment brake release system, generally designated by reference numeral 20, that preferably includes a hook mount, generally designated by reference numeral 22, mounted to the rear side wall 19 of the frame 18. The hook mount 22 includes first and second hooks 24, 26 secured to a base member 28. While the preferred embodiment includes left and right hooks 24 and 26, it is possible to construct the deployment brake release system with only a single hook.

As is known, deployment brake release lines 30 (see FIG. 1) are attached to the trailing edge 32 of a ram air parachute canopy 34 during rigging to effect downward deflection of the edge 32 during initial inflation. The deployment brake release lines 30 are subsequently released to allow full inflation of the canopy at the appropriate time and, in the case of the left and right outer brake release lines, to provide steering for the parachute after deployment brake release.

The ends of the left and right brake release lines 30a, 30b remote from the canopy are wound upon a respective spool 42 so as to be extendible and retractable under the control of a respective motor 27 which rotates the spool 42. There are thus preferably two motors and two spools, with a motor and spool combination on each of the left and right sides of the AGU frame 18.

Further detailed discussion of a deployment brake release system having hook mounts like that shown in FIGS. 2-6 of the present invention is provided in the '105 patent, previously incorporated herein by reference, and therefore will not be repeated here. While the one-time-use AGU according to the present invention is shown herein as used with a deployment brake release system such as that described in the '105 patent, the one-time-use AGU is not limited to this type of deployment brake release system but may be used with any other suitable deployment brake release system without departing from the scope of the present invention.

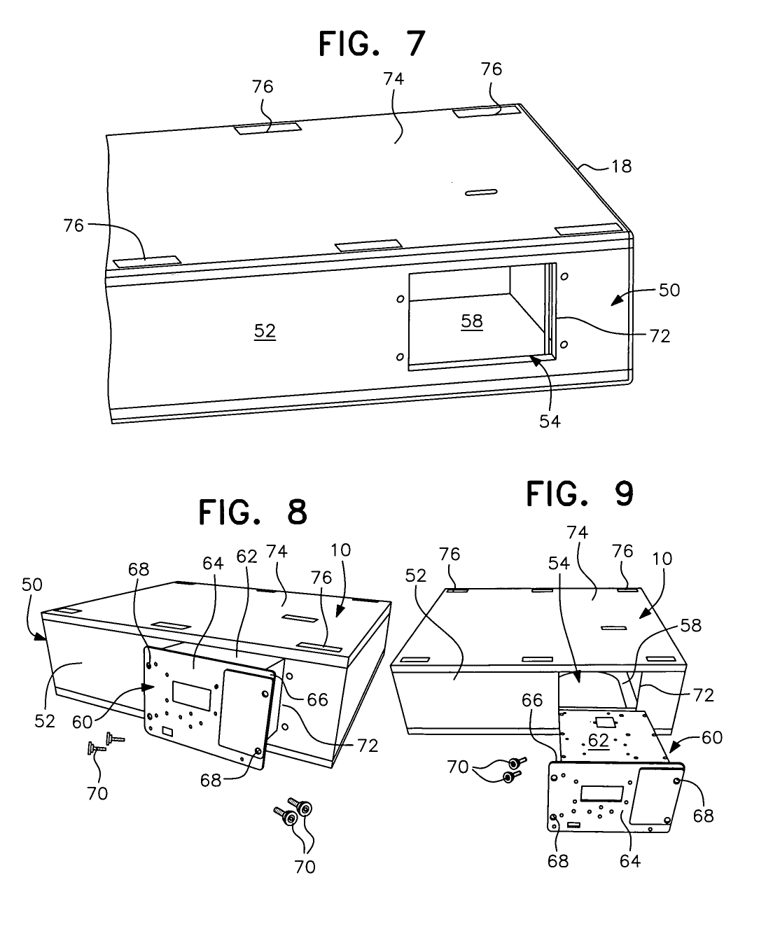

As shown in FIGS. 4-9, the right side of the frame, generally designated by reference numeral 50, includes an access portal, generally designated by reference numeral 54, in the right side wall 52. The access portal 54 defines an entranceway into a compartment 58 formed within the frame 18. The compartment 58 is sized to receive an avionics unit, generally designated by reference numeral 60.

The avionics unit 60 contains the sophisticated components needed to allow the AGU to control the parachute in flight. To protect these components, the avionics unit is preferably electromagnetically and environmentally sealed within a housing 62. The front panel 64 of the housing 62 has a flange 66 around the perimeter thereof. The flange 66 is provided with a plurality of apertures 68 for receiving fastening elements 70 that are used to secure the avionics unit 60 to the perimeter 72 of the access portal 54 of the frame exterior front wall 52 once the avionics unit is mounted in the compartment 58. As shown in FIGS. 4 and 5, once the avionics unit 60 has been inserted into the compartment 58 through the access portal 54 and secured to the perimeter 72, only the front panel 64 of the avionics unit housing is exposed and is preferably substantially flush with the exterior right side wall 52 of the frame 18.

The fastening elements 70 securing the avionics unit to the frame can be removed by accessing only the exterior right side wall 52 of the frame. This allows the avionics unit 60 to be easily and quickly mounted and/or removed from the AGU 10 while in the field or other location. Hence, after the one-time-use AGU has been deployed and recovery personnel have located it at the drop site, the avionics unit can be recovered rapidly while the remainder of the AGU frame is left at the drop site. The wooden frame of the AGU is not useful to the enemy, as it includes fewer metal components that can be used to make explosive devices or other weapons.

In addition to the avionics unit 60, the frame also contains the motors 27, motor controller 127 and batteries 13, as shown in FIG. 5. The motors are secured to the center lateral beam 115 which is preferably drilled to form recesses to receive and hold the ends of the motors securely against the frame structure. The motor controller 127 is preferably mounted against the left side wall 53 adjacent the motors 27 so as to be as remotely located from the avionics unit 60 as possible to minimize any potential interference. The battery or batteries 13 are also preferably positioned adjacent the left side wall 53 and between the lateral center beam 115 and the beam 15 reinforcing the front wall 17. The batteries 13 are accessible from outside the frame through a portal 154 in the left side wall 53 as shown in FIGS. 6 and 10. Therefore, the batteries 13 may also be easily recovered if operational conditions permit. A divider wall 117 is preferably positioned between the battery and the avionics unit 60 to form a battery compartment 119 (see FIG. 5).

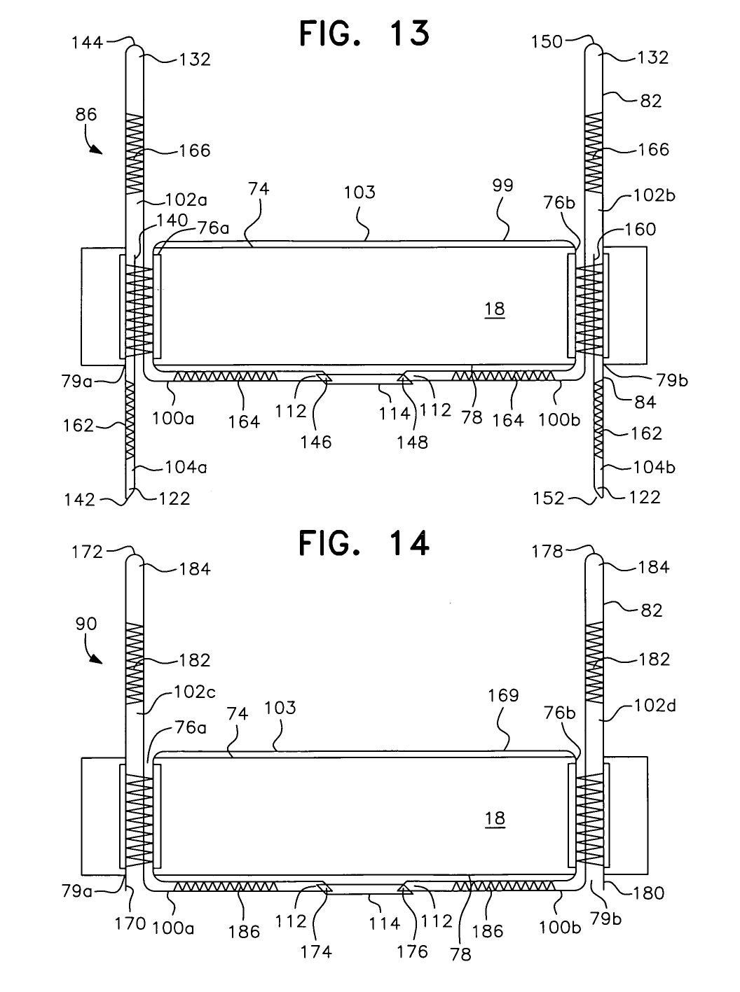

As further shown in FIGS. 4 and 6-10, the top panel 74 of the AGU frame 18 is provided with a plurality of openings 76 for receiving the upper straps 82 of the harness 80. The top panel 74 with the upper straps 82 of the harness 80 passing through the openings 76 is best shown in FIG. 11. The lower panel 78 of the AGU frame 18 is provided with similar openings 79, shown with the lower straps 84 of the harness 80 passing therethrough in FIG. 12.

While the terms “upper straps” and “lower straps” are used herein for ease of description, according to a preferred embodiment described hereinafter, the harness is actually made of three straps, a front strap 86, a back strap 88 and a middle strap 90. Each of the front, back and middle straps has an upper strap portion or “upper strap” and a lower strap portion or “lower strap”. Each of the “upper straps” and the “lower straps” is formed by folding a single respective front, back or middle strap back upon itself in a specific manner by which part of the respective strap extends through the openings 76 in the top panel to form what appears from outside the frame to be “upper straps”, while another part of the same respective strap extends back through the openings 79 in the lower panel 78 to form what appears from outside the frame to be “lower straps”. Of course, the harness could alternatively be formed of separate upper and lower straps such that the upper straps are not, in fact, an integral part of the lower straps. Hence, as used herein, the terms “upper straps” and “lower straps” are used in a relational sense as seen by the human eye and are intended to describe those portions of the harness that extend above and below the AGU frame, regardless of whether such straps are integral with one another or are separate from one another. In addition, the present invention is not limited to the use of three straps but may be embodied using any number of straps.

According to a preferred embodiment, the harness 80 includes the front strap 86, the back strap 88 and the middle strap 90 as three separate straps. The front and back straps 86, 88 each have two frame securing portions 100, two suspension line attachment portions 102 and two payload attachment portions 104. The middle strap 90 does not include payload attachment portions, but only has two frame securing and two suspension line attachment portions because, generally, only four payload attachment points are needed to secure the payload to the AGU. In an alternative embodiment, the middle strap 90 could be configured like the back and front straps to have two payload attachment portions, as well as the frame securing and suspension line attachment portions, if six or more payload attachment points were needed or desired. As with the number of harness straps, the present invention is not limited to the use of any specified number of attachment portions.

For clarity, the following description will be directed to the frame securing portions 100, the suspension line attachment portions 102, and the payload attachment portions 104 of the front strap 86, with the understanding that the same description also applies to corresponding portions of the back strap 88, as well as to the middle strap 90 with the exception of the absence in the latter of payload attachment portions. Further, in the embodiment shown, the harness 80 is made of a length of flat webbing. Other harness materials may also be used, such as cable or cord. Accordingly, wherever the term “webbing” is used herein, this term is intended to encompass other harness materials that could alternatively be used.

The frame securing portions 100 of the front strap 86 are respectively secured to one another adjacent the lower panel 78 of the frame 18. To this end, the flat webbing of the front strap is folded upon itself and sewn or otherwise fastened to form loops 112 on the ends of the frame securing portions 100. When the strap has been properly positioned, tie elements 114 are passed through the loops 112 and secured to one another to lock the harness around the frame.

The payload attachment portions 104 of the front strap are similarly constructed, having loops 122 formed at the ends of the payload attachment portions 104 by folding of the harness webbing back upon itself and fastening the overlapped portions to one another, as will be described more fully hereinafter. So, too, the suspension line attachment portions 102 also have loops 132 formed at their ends by folding and fastening of the harness webbing upon itself.

One preferred configuration for rigging the front and back straps 86, 88 of the harness 80 is illustrated in FIG. 13. Since the rigging of the front and back straps is the same, FIG. 13 will refer only to the front strap 86 to simplify designation of the elements by using only a single set of reference numerals.

As shown and as earlier noted, the front strap 86 of the harness 80 is preferably a single continuous length of webbing represented in the drawing of FIG. 13 by the line 99. The first end 140 of the strap 86 extends from inside the frame 18 adjacent the top panel 74, downwardly through one of the openings 79a to a first fold 142, after which the strap doubles back upon itself, and passes back through the opening 79a and opening 76a to a second fold 144. After the second fold 144, the strap doubles back upon itself to again pass through the openings 76a, 79a. Upon exiting the opening 79a in the lower panel 78, the strap extends across the lower panel toward the center of the lower panel 78. Near the center of the lower panel 78 the strap makes a third fold 146 where the strap doubles back upon itself, extends back across the lower panel and then turns upwardly to again pass through the openings 79a, 76a. Upon exiting the opening 76a in the top panel 74, the strap extends across the top panel to create an upper panel portion 103 and then turns downwardly to pass through openings 76b, 79b. Upon exiting the opening 79b in the lower panel, the strap extends across the lower panel and toward the center thereof where it then makes a fourth fold 148 after which the strap doubles back upon itself, extends back across the lower panel and, after turning upwardly, again passes through the openings 79b, 76b to a fifth fold 150. At the fifth fold 150, the strap doubles back upon itself to again pass downwardly through the openings 76b, 79b to a sixth fold 152. At the sixth fold 152, the strap doubles back upon itself and, finally, the second end 160 of the strap is received within the opening 79b. The end 160 may remain inside the frame 18 adjacent opening 76b or may extend out through the opening 76b.

The overlapped region of the front strap 86 between the lower panel 78 and the first fold 142 creates a first payload attachment portion 104a. Similarly, the overlapped region of the front strap between the lower panel 78 and the sixth fold 152 creates a second payload attachment portion 104b. The overlapped regions of the two payload attachment portions are respectively sewn together over a length 162 while the ends of the payload attachment portions are left unsewn to create the loops 122 formed by the first and sixth folds 142, 152. Other methods of fastening the overlapped regions may alternatively be used as would be known by persons of ordinary skill in the art.

The overlapped regions of the strap under the lower panel 78 create the frame securing portions 100a, 100b. These overlapped regions are sewn together over a length 164 while the ends are left unsewn to create the loops 112 formed by the third and fourth folds 146, 148.

The overlapped region of the upper strap between the top panel 74 and the second fold 144 creates a first suspension line connection portion 102a. Similarly, the overlapped region of the upper strap between the top panel 74 and the fifth fold 150 creates a second suspension line connection portion 102b. The overlapped suspension line connection portions are respectively sewn together, or otherwise fastened, over a length 166 while the ends are left unsewn to create the loops 132 formed by the second and fifth folds 144, 150.

The middle strap 90 is configured similarly, and is also preferably a single continuous length of webbing represented in the drawing of FIG. 14 by line 169. The first end 170 of the middle strap extends from adjacent the lower panel 78 of the AGU frame 18 upwardly through one of the openings 79a, 76a to a first fold 172. At the first fold 172, the strap doubles back upon itself, and passes back through the openings 76a, 79a. Upon exiting the opening 79a in the lower panel 78, the strap extends across the lower panel toward the center thereof where the strap makes a second fold 174 and doubles back upon itself. The strap then extends back across the lower panel 78 and then turns upwardly to again pass through the openings 79a, 76a. Upon exiting the opening 76a in the top panel 74, the strap extends across the upper panel to form an upper panel portion 103 and then turns downwardly to pass through openings 76b, 79b. Upon exiting the opening 79b in the lower panel, the strap extends across the lower panel toward the center thereof where the strap makes a third fold 176 and doubles back upon itself. The strap then extends back across the lower panel. After turning upwardly, the strap again passes through the openings 79b, 76b to a fourth fold 178. At the fourth fold 178, the strap doubles back upon itself to again pass downwardly through the opening 76b where the second end 180 of the strap is received and remains inside or adjacent the lower panel 78 of the frame 18.

The overlapped region of the middle strap between the top panel 78 and the first fold 172 creates a first suspension line attachment portion 102c. Similarly, the overlapped region of the strap between the top panel 78 and the fourth fold 178 creates a second suspension line attachment portion 102d. The overlapped regions of the suspension line attachment portions are respectively sewn together, or otherwise fastened, over a length 182 while the ends of the suspension line attachment portions 102c, 102d are left unsewn to create the loops 184 formed by the first and fourth folds 172, 178.

The overlapped regions of the middle strap 90 under the lower panel create the frame securing portions 100a, 100b. These overlapped regions are sewn together over a length 186 while the ends are left unsewn to create the loops 112 formed by the second and third folds 174, 176.

While the harness rigging has been described in connection with the frame, using the upper and lower panels and the openings in the frame as reference points to describe the configuration of the strap, in practice each harness strap is folded and sewn at the points described but before being assembled to the frame. In this pre-folded and fastened configuration, the front and back harness straps are positioned over the upper panel 74 of the frame with the payload attachment portions 104a, 104b and the frame securing portions 100a, 100b allowed to hang downwardly. The downwardly hanging “lower straps” including portions 104a and 100a are inserted together through opening 76a and opening 79a to extend below the lower panel. Similarly, downwardly hanging “lower straps” including portions 104b and 100b are inserted together through opening 76b and opening 79b to extend below the lower panel. When the payload attachment and frame securing portions are fully inserted, the upper panel portion 103 of the strap is in abutment with the upper panel 74 and the suspension line connection portions 102a, 102b are above the frame creating the “upper straps”. The frame securing portions 100a, 100b are then secured to one another using tie elements 114. By tightening the tie elements 114 to draw the strap tightly against the upper, side and lower panels, the strap is “locked” around the frame.

As with the front and back straps, the rigging of the middle strap has been described in connection with the frame but is, in fact, folded and sewn before being introduced to the frame. To mount the middle strap, the frame securing portions 100a, 100b are inserted through openings 76a, 79a and 76b, 79b, respectively, bringing the upper panel portion 103 into abutment with the upper panel 74. Tie elements 114 are then passed through the loops 112 and tightened to secure the portions 100a, 100b to one another and “lock” the strap around the frame.

In the case of all of the straps, as would be understood by persons of ordinary skill, the straps could be inserted from the bottom of the frame such that a lower panel portion analogous to the upper panel portion is created which is adjacent the lower panel. The strap frame securing portions would then be secured to one another against the upper panel with a tie fastener in the same manner as shown in FIGS. 13 and 14. In either configuration, the straps could be readily recovered after deployment by simply severing the tie elements and pulling the straps back through the openings and away from the frame.

With the foregoing folded configuration passing through the openings in the frame, the front, back and middle straps of the harness are integrated with, or wrap around, the frame and provide a strong and secure reinforcement around the AGU. As a result, there is no need for structural attachment points on the AGU frame in order to connect the AGU to the parachute and to the payload. This configuration simplifies the AGU frame design and makes such frame more cost-effective for one-time use.

The foregoing descriptions and drawings should be considered as illustrative only of the principles of the invention. The invention may be configured in a variety of shapes and sizes and is not limited by the dimensions of the preferred embodiment. Numerous applications of the present invention will readily occur to those skilled in the art. Therefore, it is not desired to limit the invention to the specific examples disclosed or the exact construction and operation shown and described. Rather, all suitable modifications and equivalents may be resorted to, falling within the scope of the invention.

What is claimed is:

1. An airborne guidance unit (AGU) for one-time use with a parachute comprising:
a frame made of biodegradable material and defining a compartment accessible from an exterior of said frame;
an avionics unit configured to be received in said compartment and removably secured to said frame; and
a harness wrapped around at least a part of the frame.

2. The AGU as set forth in claim 1, wherein said frame is made of wood and/or plywood.

3. The AGU as set forth in claim 1, wherein said frame includes a plurality of openings through which straps of the harness pass and are secured to one another to lock around said frame.

4. The AGU as set forth in claim 3, wherein said compartment is accessed through an access portal formed in an exterior wall of said frame for retrieval of said avionics unit while leaving a remainder of the frame intact.

5. The AGU as set forth in claim 4, wherein said avionics unit is sealed in a housing having a flange that abuts with a perimeter of said access portal.

6. The AGU as set forth in claim 5, wherein the avionics unit is removable from said compartment through said access portal while said harness straps remain secured to one another and locked around said frame.

7. The AGU as set forth in claim 1, wherein said harness includes at least one strap that passes through at least opening in the frame to wrap around said frame.

8. The AGU as set forth in claim 1, wherein said harness includes a plurality of straps, each strap passing through at least two openings in the frame and wrapping around said frame.

9. The AGU as set forth in claim 1, wherein said frame includes a deployment brake release system.

10. The AGU as set forth in claim 8, wherein said deployment brake release system includes at least one exterior hook mount.

11. An unmanned aerial vehicle comprising:
a parachute;
a frame made of a biodegradable material;
an avionics unit removably mounted within said frame; and
a harness wrapped around said frame and including straps for connecting the frame to suspension lines of said parachute and to a payload suspended below said frame.

12. The unmanned aerial vehicle as set forth in claim 11, wherein said avionics unit is removable through an access portal in said frame that only provides access to said avionics unit while a remainder of components contained in said frame remain fully enclosed by said frame.

13. The unmanned aerial vehicle as set forth in claim 11, wherein said vehicle includes a deployment brake release system.

14. The unmanned aerial vehicle as set forth in claim 13, wherein said deployment brake release system includes at least one exterior hook mount and a motor contained within said frame.

15. The unmanned aerial vehicle as set forth in claim 11, wherein said harness includes at least one strap configured to wrap around said frame and be secured to itself by a tie fastener to lock the harness around the frame.

16. The unmanned aerial vehicle as set forth in claim 15, wherein said frame includes an upper panel with at least first and second openings and a lower panel with at least third and fourth openings, said strap having a first portion configured to pass through the first and third openings and a second portion configured to pass through the second and fourth openings, said first and second portions after passing through said openings being secured to one another by said tie fastener.

17. The unmanned aerial vehicle as set forth in claim 11, wherein said frame is made of wood and/or plywood.
